(19) United States
(12) Patent Application Publication
(10) Pub. No.: US 2014/0268199 A1
(43) Pub. Date: Sep. 18, 2014

(54) PDF File Preview Manipulation

(71) Applicants: Daniel BARBER, Tustin, CA (US); Philip Wu, Seal Beach, CA (US)

(72) Inventors: Daniel BARBER, Tustin, CA (US); Philip Wu, Seal Beach, CA (US)

(73) Assignee: KONICA MINOLTA LABORATORY U.S.A., INC., San Mateo, CA (US)

(21) Appl. No.: 13/834,191

(22) Filed: Mar. 15, 2013

(51) Int. Cl. G06F 3/12

(52) U.S. Cl. CPC G06F 3/1297
USPC 358/1.13

(57) ABSTRACT

A method for manipulating digital files, including the steps of processing all pages of a document from a remote server to generate page images for online displaying of the images, displaying a preview of the page images of the document on a local computer connected to the remote server via a network, temporarily saving information of a user modification, changing only the preview of the page images on the local computer according to the user modification without modifying the document itself on the remote server, and if the modification is confirmed, retrieving the saved information of the user modification and modifying the document according to the user modification.

### BACKGROUND OF THE INVENTION

1. Field of the Invention

This invention relates to a method of manipulating digital files, and in particular, it relates to manipulating previews of portable document format (PDF) files.

2. Description of Related Art

Many digital files are transmitted and processed online today. For example, an online file management and distribution service provider operating a “webstore” server may receive documents in PDF, i.e., PDF files, uploaded by users who have logged on to the webstore server. The webstore server usually provides a web browser for the users to preview the PDF files online for verification and manipulation purposes.

In order to do so, the webstore server needs to first process the PDF pages of the document into images such as Tagged Image File Format (TIFF) or Joint Photographic Experts Group (JPEG) images. Then the webstore server generates thumbnail images of the original page images of the document, and displays the thumbnails on the web browser. When a user is viewing these thumbnails of on the web browser, the user is allowed to modify the document, e.g., rotating a page, cropping a page, deleting a page, combining pages, etc.

Once satisfied with the modification made to the PDF file, the user can submit the file for further handling by the webstore, e.g., storing the file in a database or printing it in hard copies.

Typically when a user is making modifications to certain pages of a document as the user previews the thumbnails on the web browser, the webstore server will re-process the original PDF document with the changes made to these pages of the document. For example, if a page of the document is rotated, the server will re-process the PDF file with the page rotated, and then re-generate the image of the rotated page.

There is a need for an easy and practical solution that can provide a new approach for manipulating previews of PDF files uploaded online by users to a web server, where the users may make modifications before submitting the file for further handling.

### SUMMARY

One problem with the conventional online PDF page preview process mentioned above is that it often results a heavy server load because every time a modification is made by a user to a document, the server needs to re-process the PDF file and re-generate the page images and thumbnails for displaying the modified document to the user.

In addition, a user often changes his or her mind after previewing a modification made to a document. For example, when a user crops a page, the server needs to re-process the PDF file with the cropping and re-generate the image and thumbnail of the cropped page for displaying it to the user on the web browser. However, after previewing the cropped a page, the user may decide not to crop the page, and the server needs to re-process the PDF file without the cropping and re-generate the image and thumbnail of the un-cropped page again for displaying it to the user on the web browser. As a result the first re-processing of the PDF file with the cropped page is entirely wasted. This further increases the server overhead.

The embodiments of the present invention are directed to a new method of manipulating previews of digital files after the files are uploaded online to a web server, to reduce the use and waste of server processing load and overhead.

Some embodiments of the present invention provide a method for manipulating previews of a PDF file after a document in PDF is uploaded online by a user to a web server, where the modifications made by the user to the pages of the document of the uploaded file are only made to the thumbnails of the document pages previewed on a web browser, but not made to the document itself until the user confirms the modification, in order to reduce the use and waste of the server processing load and overhead.

Some embodiments of the present invention also provide a method for manipulating previews of a PDF file after a document in PDF is uploaded online by a user to a web server, where the modifications made by the user to the pages of the document of the uploaded file are instantaneously shown in the thumbnails of the document pages, allowing the user to confirm the changes made or make further changes before any modification is made to the document itself, also in order to reduce the use and waste of the server processing load and overhead.

Some embodiments of the present invention additionally provide a method for manipulating previews of a PDF file after a document in PDF is uploaded online by a user to a web server, where only information of modifications made by the user to the pages of the document of the uploaded file are saved but no change to the document itself is made or saved or processed until the user confirms the modification, in order to further reduce the use and waste of the server processing load and overhead.

Some embodiments of the present invention further provide a method for manipulating previews of a PDF file after a document in PDF is uploaded online by a user to a web server, where the information of modifications made by the user to the pages of the document of the uploaded file are saved and can be retrieved so that the user may go back to an earlier modification that may be discarded in the modification process, without re-processing the document itself for any of the intermediary steps of the modification, still in order to reduce the use and waste of the server processing load and overhead.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, one of the exemplary embodiments of the present invention provides a method for manipulating digital files uploaded or provided to a web server for further handling. According to this exemplary embodiment of the present invention, the digital file manipulation process comprises the steps of: processing all pages of a document from a remote server to generate page images for online displaying of the images; displaying a preview of the page images of the document on a local computer connected to the remote server via a network; temporarily saving information of a user modification; changing only the preview of the page images on the local computer according to the user modification without modifying the document itself on the remote server; and if the modification is confirmed, retrieving the saved information of the user modification and modifying the document according to the user modification.

In a further aspect, another one of the exemplary embodiments of the present invention provides a computer software program product that causes a data processing apparatus to perform the above described methods. The computer program product includes a computer usable non-transitory medium (e.g. memory or storage device) having a computer readable program code embedded therein for controlling a data processing apparatus, the computer readable program code configured to cause the data processing apparatus to execute the above described processes.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic block diagram illustrating an exemplary online environment according to one of the embodiments of the present invention.

FIG. 2 is a schematic block diagram illustrating an exemplary data processing apparatus such as a computer or server having a data processing unit according to one of the embodiments of the present invention.

FIG. 3 is a schematic block diagram illustrating an exemplary data processing apparatus such as a printer or copier having a data processor or controller unit according to the embodiment of the present invention.

FIG. 4 is a flow chart diagram illustrating an exemplary process according to one of the embodiments of the present invention.

### DETAILED DESCRIPTION OF PREFERRED EMBODIMENTS

Embodiments of the present invention provide a method and system for manipulating previews of a PDF file on a web browser after a document in PDF are uploaded online by a user to a web server, where any modification made by the user to the pages of the document of the uploaded file is only made to the thumbnails of the document pages but not to the document itself, until the user confirms the modification. Also, any user modification are instantaneously shown in the thumbnails of the document pages, allowing the user to confirm the changes made or make further changes before any modification is made to the document itself. Additionally, only the information of user modifications is saved but no change to the document itself is made or saved or processed, unless the user confirms the modification. Furthermore, the information of user modifications can be retrieved so that the user may go back to an earlier modification made in the modification process, without the server re-processing the document itself for any of the intermediary modifications. All these features help reduce the use and waste of the server processing load and overhead.

Referring to FIG. 1, there is shown a schematic block diagram illustrating an exemplary online system set up or arrangement 10 in which various embodiments of the present invention may be implemented. The exemplary online environment includes a server such as a webstore server 20 operated by an online digital file distribution, production, storage or management service provider such as a publisher, a bookstore, a file depository, etc., a user or customer computer or terminal 30, one or more servers 40 operated by third party content or web service providers, and one or more servers operated by print shops or printers 50, connected via one or more computer network 60 such as the Internet or other communication links.

An operator of the online service provider may use the server 20 to access the network 60 and interact with the users or customers, the third party content providers, and the printers. A user or customer may use the computer or terminal 30, or similar suitable devices such as a laptop computer, a tablet computer, an e-reader, or a smart phone, etc., to access the computer network 10 and interact with the online service provider, the third party content providers, and the printers. Likewise, third party content providers and print shop managers may their respective servers 40 and 50 to access the network 10 and interact with each other and the online service provider and users.

The online service provider generally provides an integrated online service that allows users to search, access, upload or download documents stored as electronic digital files in internal or external file storages or databases connected to the server 20 and/or the network 60. The online service may also accept users' request to further handle the documents such as distribute them in digital files or produce them in hard copies.

The print shop or printer may be a professional print shop equipped with printers and various other image reproduction machines for producing printed products such as books, booklets, and other printed publications, etc. The print shop or printer may provide similar services as the online service provider, particularly when users submit print-on-demand (POD) orders to produce and purchase printed products.

Computers and servers 20, 30, 40 and 50 may be computers, server computers, or computer or server systems, such as webservers, where the computer software program(s) and/or application(s) implementing the various processes of the exemplary embodiments of the present invention may be installed and executed.

Typically these computers and servers provide a user interface (UI) or graphic user interface (GUI) to allow users or operators to interact with the computer software programs and applications to perform various steps of the process.

In this Application the term “server” generally refers to any computer, server, server computer, server instance, computer or server system, data processor, controller, data processing unit or apparatus, or any suitable system, apparatus or device, and any computer software program or application that are installed or executed on such system, apparatus or device, that may be used to implement the methods or carry out the processes provided by the embodiments of the present invention.

A user typically accesses the computers and server 20, 30, 40 or 50 by using computer programs or applications on the users' own computer or on a server that the user can access through a user computer or terminal, such as one of the servers 20, 40 or 50.

In this Application the term “user” generally refers to anyone who uses the method or related apparatus provided by the embodiments of the present invention.

In addition, when not otherwise specified, in this Application the terms “user” and “server” may be used interchangeably to refer to a user who uses a server and/or a server that is used by a user to carry out the steps of a digital file manipulation process according to the exemplary embodiments of the present invention.

The physical locations or the commercial relationship among the various components of the online environment shown in FIG. 1 are not important. For example, the server of the online service provider may be located at the print shop, or a separate institution, organization or commercial establishment.

As mentioned earlier, in one aspect, an exemplary embodiment of the present invention is embodied a computer program product that causes a data processing apparatus to perform the exemplary embodiments of the methods of the present invention. The computer program product includes a computer usable non-transitory medium (e.g. memory or storage device) having a computer readable program code embedded therein for controlling a data processing apparatus, where the computer readable program code is configured to cause the data processing apparatus to execute the process of the present invention as shown in FIG. 2.

Referring to FIG. 2, there is shown a schematic block diagram illustrating an exemplary server 100, whereupon various embodiments of the present invention may be implemented. The server 100 typically includes a user input device 110 including, for example, a keyboard and a mouse. The input device 110 may be connected to the server 100 through a local input/output (I/O) port 120 to enable an operator and/or user to interact with the server 110. The local I/O 120 is also provided for local connections via direct links to other electronic devices such as a file storage, a monitor and/or a printer.

The server 100 typically also has a network I/O port 130 for connection to a computer network such as the Internet, so that the server 100 may remotely communicate with the other servers connected to the computer network.

The server 100 typically has a data processor/controller unit 140 such as a central processor unit (CPU) that controls the functions and operations of the server 100. The data processor/controller unit 140 is connected to various memory devices such as a random access memory (RAM) device 150, a read only memory (ROM) device 160, and a storage device 170 such as a hard disc drive or solid state memory. The storage device 170 may be an internal memory device or an external memory device such as a file storage device.

The computer software program codes and instructions for implementing the various embodiments of the present invention may be installed or saved on one or more of these memory devices. The data processor/controller unit 140 executes these computer software programs and instructions to perform the functions and carry out the operations to implement the process steps of the various embodiments of the present invention.

The server 100 typically also includes a display device 180 such as a video monitor or display screen which may be connected to the local I/O 120. The input device 110 and the display device 180 together provide a user interface (UI) which allows a user to interact with the server 100 to perform the steps of the process according to the various embodiments of the present invention.

The input device 110 and the display device 180 may be integrated into one unit, such as a touch screen display unit, to provide a more easy and convenient UI for user interaction with the server 100.

It is understood that the server 100 may be any suitable computer or computer system. Preferably for use, for example, by an online service provider, the server 100 is a webstore server. However, for use by a member of the general public, the server 100 may be a desktop computer, a laptop computer, a notebook computer, a netbook computer, a tablet computer, a hand-held portable computer or electronic device, a smart phone, or any suitable data processing apparatus that has suitable data processing capabilities.

Referring to FIG. 3, there is shown a schematic block diagram illustrating another exemplary data processing apparatus embodied in a document reproduction device such as a printer or copier 200, whereupon various embodiments of the present invention may also be implemented.

The printer or copier 200 typically includes an integrated control panel 210 which includes a keypad and a display screen, or a touch screen that provides both the input and display functions.

The printer or copier 200 may has a local I/O port 220 for connection with other local devices such as a computer. The printer or copier 200 typically also has a network I/O port 230 for connection to a network such as the Internet so that the printer or copier 200 may remotely communicate with the other computers and servers connected to the Internet.

The printer or copier 200 typically has a data processor/controller unit 240 that controls the functions and operations of the printer or copier 200. The data processor/controller unit 240 is connected to various memory devices such as a RAM device 250, a ROM device 260, and a storage device 270 such as a hard disc drive or solid state memory.

The storage device 270 may be an internal memory device or an external memory device such as a hard disc drive. The computer software programs and instructions for implementing the various embodiments of the present invention may be installed or saved on one or more of these memory devices.

The data processor/controller unit 240 executes these computer software programs and instructions to perform the functions and carry out the operations to implement the process steps of the various embodiments of the present invention.

It is understood that the data processing apparatus 200 may be any suitable document reproduction device or system, such as a printer, a copier, a scanner, a facsimile machine, an all-in-one printer, a printing system, or any suitable document reproduction device that has suitable data processing capabilities.

Referring to FIG. 4, there is shown a flow chart diagram illustrating an exemplary process in accordance with one of the embodiments of the present invention. The process begins at Step S10 with a user opens an uploaded PDF document which may be stored at a remote webstore server or print shop server, as the user may need to preview the document on the user's local computer to see, for example, whether it is the correct document or whether there is any change needs to be made to the document. The document may be previously uploaded to the remote server, and in order to open it the user may need to retrieve it from the server and download it to the user's local computer via the network through which the local user computer and the remote webstore or print shop server are connected. The user computer provides a web browser for the user to preview the document online for such purposes, e.g., verifying contents and/or modifying the appearance of the document.

At Step S12, the user computer first processes the pages of the document from PDF into, e.g., TIFF or JPEG images. Alternatively if the document is not downloaded to the user computer, then the remote server may process the pages of the document into images and transmit the page images to the user computer for displaying by the web browser. At Step S14 the user computer generates thumbnails of the document page images, and displays the thumbnails on the web browser as previews to the user on the user computer. Alternatively the remote server may generate the thumbnails and transmit them to the user computer for displaying by the web browser. When the user is viewing the thumbnails on the web browser, the user can at Step S16 modify one or more pages of the document, e.g., rotating, resizing, cropping, deleting, or combining pages, etc., on the user computer.

These steps preferably performed at the user computer may be easily handled by a user on via, e.g., a web browser application that runs on the user computer. Once a user has successfully uploaded a PDF document to the server, and the PDF document has been subsequently processed successfully, the user can be presented with options of several available actions, such as rotation, resizing, cropping, removing and combining one of more pages of the PDF document.

For example, at Step S14, the user can first select the pages of the PDF document that the user wishes to modify by selecting the appropriately selectable page element, such as a checkbox or by highlighting the proper images displayed by the browser. Once any number of pages has been selected, the user will be presented with any available options in the form of selectable links, such as a standard button, image button, or link button. When the user selects an action on the selected pages, the data regarding these modifications will be saved either to the server or to a third party, i.e., at Step S18 the user computer temporarily saves) the information of the user's modification, e.g., a command to rotate the second page of the document, e.g., in a cache memory of the user computer, or alternatively in a database of the remote webstore or print shop server or even a third party server. At Step 20 the user computer makes changes only to the thumbnails in the preview without making any modification to the actual PDF file itself. The change to the thumbnails is instantaneous and the changed thumbnail(s) is displayed as a preview to the user on the user computer. The changes are shown to the user on, e.g., the web browser, immediately by refreshing the selected pages and manipulating them via code, but are not applied to the original PDF document at this point. Typically the thumbnails are smaller in size and lower in resolution, so any change to the thumbnails requires much less server resources and overhead to change them. Since there is no change made to the PDF file, there is no re-processing (e.g., image-generating) of the PDF file, the use and waste of computer processing load and overhead is reduced.

As Step S22, when the user previews the modified thumbnails on the user computer, the user may confirm or reverse the modification. If the user decides not to make the modification, at Step S24 the user computer discards the previously saved information of the user's modification, and nothing further need to be done.

If the user is satisfied with and confirms the modification, at Step S26 the user computer retrieves from its memory the previously saved information of the user's modification, e.g., the command to rotate the second page of the document. If the user does not confirm and exits the page or closes the browser, the changes are not applied to the PDF document. The user must select the appropriate save option displayed on the browser in order to save the modifications permanently.

At Step S28 the user computer modifies the PDF file according to the confirmed information of the user's modification, e.g., rotating the second page of the document. At Step S30 the user computer transmits the modified PDF document to the remote webstore or print shop server for storage.

Alternatively, at Step S32 the user computer transmits the confirmed information of the user's modification to the remote webstore or print shop server. At Step 34 the remote server modifies the PDF file according to the confirmed information of the users' modification.

Finally, at Step S36 the remote server saves the modified PDF file in a storage (which also happens after Step S30), which may be later accessed for retrieval as an electronic digital document or printing in hard copies.

Optionally the server may re-process the PDF file into images which will reflect the modification made to the PDF file. It may not be necessary to re-process the whole file. For example, if the only modification is the rotation of the second page of the document, then only the second page of the document needs to be re-processed, e.g., generating a new image of the second page for the modified PDF file. The reprocessed page images may be displayed again by the web browser on the user computer. The modified document may be submitted by the user for further handling such as distribution or printing.

Typically the above described Steps S10 through S32 are performed by the user computer, and Steps S34 through S36 are performed by the remote webstore or print shop server, as indicated by the dotted boxes in FIG. 4, where the top dotted box indicating the steps typically performed by the user computer, and the bottom dotted box indicating the steps typically performed by the remote server. Of course as noted above, certain steps in the upper dotted box, e.g., Steps S12 and S28, may also be performed by the remote server when appropriate.

The various embodiments of the present invention method have many advantages. For example, since any modification made by a user to the pages of the uploaded document is only “processed” at the thumbnail-level, the preview of the modification can be shown almost instantaneously to allow the user to confirm the changes made or make further changes before any modification is made to the document itself.

In addition, the saved user modification information may allow the user to revert back to a previously tried change without losing the trace of the user's modification process when the user is going back and forth with alternative modification effects.

Moreover, since only the information of user modifications is saved but no change to the document itself is made or saved or processed, the use and waste of the server processing load and overhead are reduced.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for manipulating digital files, comprising the steps of:
processing all pages of a document from a remote server to generate page images for online displaying of the images;
displaying a preview of the page images of the document on a local computer connected to the remote server via a network;
temporarily saving information of a user modification;
changing only the preview of the page images on the local computer according to the user modification without modifying the document itself on the remote server; and
if the modification is confirmed, retrieving the saved information of the user modification and modifying the document according to the user modification.

2. The method of claim 1, wherein the preview is displayed in a web browser provided by the local computer.

3. The method of claim 1, further comprising a step of generating thumbnails of the page images of the document as the preview.

4. The method of claim 1, further comprising a step of, if the modification is not confirmed, discarding the temporarily saved information of the user modification.

5. The method of claim 1, where the step of processing the document to generate page images is performed by the local computer.

6. The method of claim 1, where the step of processing the document to generate page images is performed by the remote server.

7. The method of claim 6, further comprising a step of transmitting the generated page images from the remote server to the local computer through the network.

8. The method of claim 1, where the step of modifying the document according to the user modification is performed by the remote server.

9. The method of claim 1, where the step of modifying the document according to the user modification is performed by the local server.

10. The method of claim 9, further comprising a step of transmitting the modified document from the local computer to the remote server through the network.

11. A computer program product comprising a non-transitory computer usable medium having a computer readable code embodied therein for controlling a data processing apparatus, the computer readable program code configured to cause the data processing apparatus to execute a process for manipulating digital files, the process comprising the steps of:
processing all pages of a document from a remote server to generate page images for online displaying of the images;
displaying a preview of the page images of the document on a local computer connected to the remote server via a network;
temporarily saving information of a user modification;
changing only the preview of the page images on the local computer according to the user modification without modifying the document itself on the remote server; and
if the modification is confirmed, retrieving the saved information of the user modification and modifying the document according to the user modification.

12. The computer program product of claim 11, wherein the preview is displayed in a web browser provided by the local computer.

13. The computer program product of claim 11, wherein the process further comprises a step of generating thumbnails of the page images of the document as the preview.

14. The computer program product of claim 11, wherein the process further comprises a step of, if the modification is not confirmed, discarding the temporarily saved information of the user modification.

15. The computer program product of claim 11, where the step of processing the document to generate page images is performed by the local computer.

16. The computer program product of claim 11, where the step of processing the document to generate page images is performed by the remote server.

17. The computer program product of claim 16, wherein the process further comprises a step of transmitting the generated page images from the remote server to the local computer through the network.

18. The computer program product of claim 11, where the step of modifying the document according to the user modification is performed by the remote server.

19. The computer program product of claim 11, where the step of modifying the document according to the user modification is performed by the local server.

20. The computer program product of claim 19, wherein the process further comprises a step of transmitting the modified document from the local computer to the remote server through the network.
